(19) United States
(12) Patent Application Publication
(10) Pub. No.: US 2018/0155624 A1
(43) Pub. Date: Jun. 7, 2018

(54) LIGHT-SPLITTING MATERIAL AND PREPARATION METHOD THEREOF, GRATING AND APPLICATION METHOD THEREOF, AND DISPLAY APPARATUS

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Xiaojuan Wu, Beijing (CN); Xiaoqing Peng, Beijing (CN)

(21) Appl. No.: 15/511,232

(22) PCT Filed: May 26, 2016
(86) PCT No.: PCT/CN2016/083421

§ 371 Date: Mar. 14, 2017

(30) Foreign Application Priority Data
Mar. 10, 2016 (CN) 201610136345.9

(51) Int. Cl. C09K 19/54; G02B 27/22; G02F 1/1343; C08L 23/08

(52) U.S. Cl. CPC C09K 19/542; C08L 23/0853; G02F 1/1343; G02B 27/22

(57) ABSTRACT

The present disclosure discloses a light-splitting material and a preparation method thereof, a grating and an application method thereof, and a display apparatus. The light-splitting material comprises a liquid crystal mixture and an ethylene-vinyl acetate copolymer, wherein the liquid crystal mixture comprises a negative nematic liquid crystal, a chiral additive and an ionic liquid, and the mass ratio of the liquid crystal mixture to the ethylene-vinyl acetate copolymer is in a range of 3/7 to 8/2. In the present disclosure, since it is not required to continuously apply an electric field to the grating upon 2D display and 3D display, it is only required to apply an electric field upon the switching between 2D display and 3D display, it is possible to reduce the energy consumption of 3D liquid crystal display apparatuses, improve the display effect, and elongate the stand-by time.

### FIELD OF THE INVENTION

The present disclosure relates to the technical field of display, and particularly to a light-splitting material and a preparation method thereof, a grating and an application method thereof, and a display apparatus.

### BACKGROUND OF THE INVENTION

The existing naked-eye 3D liquid crystal display may be divided into a shielding type naked-eye 3D liquid crystal display and a lens type naked-eye 3D liquid crystal display. Since the shielding type 3D liquid crystal display may be compatible with the processes of, for example, liquid crystal display panels or organic electroluminescent display panels, it has been widely investigated. In the existing shielding type 3D liquid crystal display, a TN type liquid crystal grating is typically provided on a light emergent side of a display panel. This 3D liquid crystal display technology is relatively mature and has low price. Furthermore, the switching between a 2D display mode and a 3D display mode may be achieved. However, since it is required to simultaneously apply a voltage to a 2D display panel and a liquid crystal grating when 3D display is carried out in the existing naked-eye 3D liquid crystal display apparatus, a relatively large energy consumption is caused, which is disadvantageous to energy saving, and thus the stand-by time is affected.

### SUMMARY OF THE INVENTION

For solving the above problems, the present disclosure provides a light-splitting material and a preparation method thereof, a grating and an application method thereof, and a display apparatus, so as to solve the above problems present in the existing 3D liquid crystal display apparatuses.

To this end, the present disclosure provides a light-splitting material comprising a liquid crystal mixture and an ethylene-vinyl acetate copolymer, wherein the liquid crystal mixture comprises a negative nematic liquid crystal, a chiral additive, and an ionic liquid, and the mass ratio of the liquid crystal mixture to the ethylene-vinyl acetate copolymer is in a range of 3/7 to 8/2.

Optionally, the mass ratio of the liquid crystal mixture to the ethylene-vinyl acetate copolymer is 7/3, 6/4, or 5/5.

Optionally, the mass proportion of the negative nematic liquid crystal is in a range of 69% to 98.9%, the mass proportion of the chiral additive is in a range of 1% to 30%, and the mass proportion of the ionic liquid is in a range of 0.1% to 1%, relative to the total mass of the liquid crystal mixture.

Optionally, the mass proportions of the negative nematic liquid crystal, the chiral additive, and the ionic liquid are 97.9%, 2.0%, and 0.1% respectively; or

the mass proportions of the negative nematic liquid crystal, the chiral additive, and the ionic liquid are 74.8%, 25.0%, and 0.2% respectively; or

the mass proportions of the negative nematic liquid crystal, the chiral additive, and the ionic liquid are 94.85%, 5.0%, and 0.15% respectively.

The present disclosure further provides a preparation method of any of the light-splitting materials described above, and the preparation method of the light-splitting material comprises the steps of:

uniformly mixing a negative nematic liquid crystal, a chiral additive, and an ionic liquid to form a liquid crystal mixture; and

uniformly mixing the liquid crystal mixture with an ethylene-vinyl acetate copolymer to form the light-splitting material.

The present disclosure further provides a grating, which comprises a first substrate and a second substrate which are oppositely provided, wherein a light-splitting layer is provided between the first substrate and the second substrate, the light-splitting layer comprises a plurality of light-transmitting areas and light-splitting areas which are provided at intervals, the light-splitting area is provided with a light-splitting unit, the light-splitting unit comprises a light-splitting material layer, and the material forming the light-splitting material layer includes any one of the light-splitting materials described above.

Optionally, the light-splitting unit comprises a first electrode which is provided on a side of the first substrate close to the second substrate and a second electrode which is provided on a side of the second substrate close to the first substrate, wherein the light-splitting material layer is provided between the first electrode and the second electrode.

Optionally, a first alignment layer is provided on a side of the first electrode close to the light-splitting material layer, a second alignment layer is provided on a side of the second electrode close to the light-splitting material layer, and the light-splitting material layer is provided between the first alignment layer and the second alignment layer.

Optionally, the light-splitting material layer has a thickness in a range of 2 μm to 50 μm.

Optionally, the light-splitting material layer has a thickness of 10 μm or 15 μm.

The present disclosure further provides an application method of any one of the gratings described above, and the application method of the grating comprises the steps of:

applying a direct-current electric field to the light-splitting material layer to make the light-splitting material layer opaque; and

applying an alternating-current electric field to the light-splitting material layer to make the light-splitting material layer light-transmitting.

Optionally, it further comprises the step of:

removing the direct-current electric field after applying the direct-current electric field to the light-splitting material layer to maintain the light-splitting material layer in an opaque state.

Optionally, it further comprises the step of:

removing the alternating-current electric field after applying the alternating-current electric field to the light-splitting material layer to maintain the light-splitting material layer in a light-transmitting state.

Optionally, the initial state of the light-splitting material layer to which an electric field is not applied is a light-transmitting state.

the present disclosure further provides a 3D display apparatus, which comprises a display panel and any one of the gratings described above, wherein the grating is provided on a light emergent side of the display panel, the display panel comprises a third substrate and a fourth substrate which are oppositely provided, and the second substrate on a light incident side of the grating and the third substrate on the light emergent side of the display panel are the same substrate.

The present disclosure has the following advantageous effects.

In the display apparatus according to this disclosure, since it is not required to continuously apply an electric field to the grating upon 2D display and 3D display, it is only required to apply an electric field upon the switching between 2D display and 3D display, and therefore, it is possible to reduce the energy consumption of 3D liquid crystal display apparatuses, improve the display effect, and elongate the stand-by time.

### BRIEF DESCRIPTION OF THE DRAWINGS

FIG. 1 is a flow chart of a preparation method of a light-splitting material provided in Example 2 of this disclosure;

FIG. 2 is a structural schematic diagram of a 3D display apparatus;

FIG. 3 is a schematic diagram of the transmittance of a liquid crystal mixture having a reflection wavelength less than 380 nm varying with the wavelength;

FIG. 4 is a schematic diagram of the transmittance of a liquid crystal mixture having a reflection wavelength greater than 780 nm varying with the wavelength;

FIG. 5 is a schematic diagram of the molecular arrangement of the light-splitting material of the light-splitting material layer 21 shown in FIG. 2 in the initial state;

FIG. 6 is a schematic diagram of the molecular arrangement of the light-splitting material of the light-splitting material layer 21 shown in FIG. 2 when a direct-current electric field is applied;

FIG. 7 is a schematic diagram of the molecular arrangement of the light-splitting material of the light-splitting material layer 21 shown in FIG. 2 when a direct-current electric field is removed;

FIG. 8 is a schematic diagram of the molecular arrangement of the light-splitting material of the light-splitting material layer 21 shown in FIG. 2 when an alternating-current electric field is applied; and

FIG. 9 is a flow chart of the application method of a grating provided in Example 4 of this disclosure.

### DETAILED DESCRIPTION OF THE INVENTION

In order to allow the person skilled in the art to better understand the technical solution of this disclosure, the light-splitting material and the preparation method thereof, the grating and the application method thereof, and the display apparatus provided by this disclosure will be described in detail in conjunction with accompanying drawings.

### Example 1

This Example provides a light-splitting material, wherein the light-splitting material comprises a liquid crystal mixture and an ethylene-vinyl acetate copolymer, wherein the liquid crystal mixture comprises a negative nematic liquid crystal, a chiral additive, and an ionic liquid, and wherein the mass ratio of the liquid crystal mixture to the ethylene-vinyl acetate copolymer is in a range of 3/7 to 8/2. The light-splitting material is used for transmitting a light beam or shielding a light beam. Optionally, the mass ratio of the liquid crystal mixture to the ethylene-vinyl acetate copolymer is 7/3, 6/4, or 5/5.

In this example, the ethylene-vinyl acetate copolymer is a high-molecular polymer which is distinguished from small molecules, and has a relatively large viscosity, a relatively high molecular weight, and a linear structure, so as to be capable of forming a network structure and being used for anchoring the molecular arrangement of small molecule substances. The ethylene-vinyl acetate copolymer exhibits a network-like backbone structure and a flake-like microscopic morphology, and can stabilize small molecules in very small mesh pores, so as to be capable of fixing a liquid crystal mixture in a certain microdomain and preventing the flow of the liquid crystal mixture. Therefore, the ethylene-vinyl acetate copolymer may anchor a mixture of a negative nematic liquid crystal, a chiral additive, and an ionic liquid in a certain microdomain to form a thin-film like structure.

The ethylene-vinyl acetate copolymer is not particularly limited, as long as it can anchor a mixture of a negative nematic liquid crystal, a chiral additive, and an ionic liquid in a certain microdomain, and for example, it may be a commercially available product.

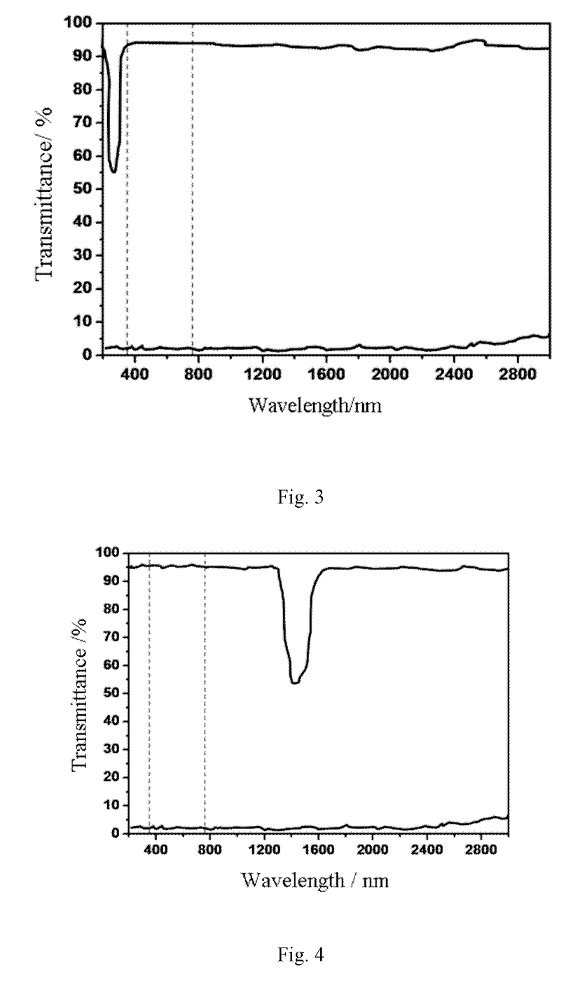

When no voltage is applied, a mixture containing a negative nematic liquid crystal, a chiral additive, and an ionic liquid exhibits a planar texture of a cholesteric liquid crystal at room temperature. By adjusting the types or contents of the chiral additives, the light having wavelengths less than 380 nm or more than 780 nm may be reflected by the mixture, while the light in the visible light region (380-780 nm) may be completely transmitted through the mixture. That is, the mixture exhibits a transparent state and has a transmittance close to 100%. FIG. 3 is a schematic diagram of the transmittance of a liquid crystal mixture having a reflection wavelength less than 380 nm varying with the wavelength. FIG. 4 is a schematic diagram of the transmittance of a liquid crystal mixture having a reflection wavelength greater than 780 nm varying with the wavelength. As shown in FIGS. 3 and 4, by adjusting the types or contents of the chiral additives in the liquid crystal mixture, the liquid crystal mixture may reflect the light having wavelengths less than 380 nm or more than 780 nm and transmit the visible light having wavelengths of 380 nm to 780 nm.

When a direct-current electric field is applied, the orientation of the negative nematic liquid crystal will become disordered under the combined action of the direct-current electric field and ion movements. Therefore, the mixture containing a negative nematic liquid crystal, a chiral additive, and an ionic liquid changes into a focal conic texture from a planar texture, and exhibits an opaque state and has a transmittance close to 0%. After the direct-current electric field is removed, the liquid crystal molecules remain in a disordered state, i.e., an opaque state. When a high-frequency alternating-current electric field is applied, since the negative nematic liquid crystal exhibits a planar orientation under a high-frequency alternating-current electric field, the liquid crystal molecules change into the initial planar orientation state, i.e., a transparent state, from the disordered state.

The negative nematic liquid crystal is not particularly limited, and for example, MAT-14-1486 purchased from Merk Corporation, NA-0716 purchased from DIC Corporation, or SLC10V513-200 purchased from Shijiazhuang Chengzhi Yonghua Display Materials Co., Ltd., may be exemplified.

The chiral additive is not particularly limited, and for example, R811, S811, CB15, ZLI-4572, etc., purchased from Merk Corporation may be exemplified.

The ionic liquid is not particularly limited, and an imidazole-type ionic liquid, for example 1-ethyl-3-methylimidazole bromide, cetyltrimethylammonium bromide, etc., may be exemplified.

In this Example, the mass proportion of the negative nematic liquid crystal is in a range of 69% to 98.9%, the mass proportion of the chiral additive is in a range of 1% to 30%, and the mass proportion of the ionic liquid is in a range of 0.1% to 1%, relative to the total mass of the liquid crystal mixture. Preferably, the mass proportions of the negative nematic liquid crystal, the chiral additive, and the ionic liquid are 97.9%, 2.0%, and 0.1% respectively. Alternatively, the mass proportions of the negative nematic liquid crystal, the chiral additive, and the ionic liquid are 74.8%, 25.0%, and 0.2% respectively. Alternatively, the mass proportions of the negative nematic liquid crystal, the chiral additive, and the ionic liquid are 94.85%, 5.0%, and 0.15%, respectively.

### Example 2

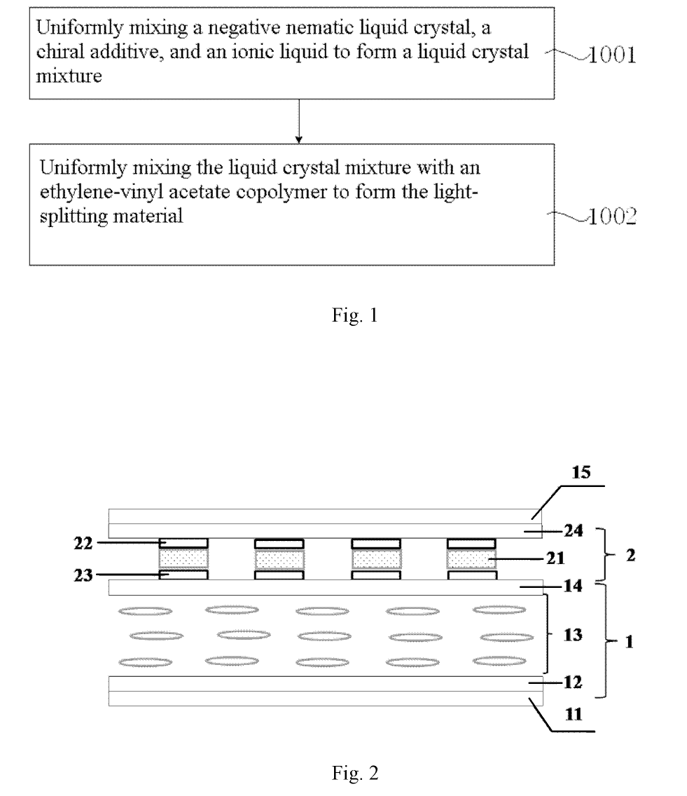

FIG. 1 shows a flow chart of a preparation method of a light-splitting material. This preparation method may be used to prepare the light-splitting material in Example 1. As shown in FIG. 1, the preparation method of the light-splitting material comprises the steps of:

Step 1001: uniformly mixing a negative nematic liquid crystal, a chiral additive, and an ionic liquid to form a liquid crystal mixture.

Step 1002: uniformly mixing the liquid crystal mixture with an ethylene-vinyl acetate copolymer to form the light-splitting material.

In this example, a negative nematic liquid crystal, a chiral additive, and an ionic liquid are firstly uniformly mixed to form a liquid crystal mixture, and the liquid crystal mixture is then mixed with an ethylene-vinyl acetate copolymer to form the light-splitting material, wherein the specific contents about the mass proportions of the negative nematic liquid crystal, the chiral additive, and the ionic liquid and the mass ratio of the liquid crystal mixture to the ethylene-vinyl acetate copolymer can be referred to the description in Example 1.

For example, a negative nematic liquid crystal, a chiral additive, and an ionic liquid are weighed according to the predetermined proportions in Example 1, dissolved in an organic solvent (such as dichloromethane, acetone, etc.), sealed in a magnetic stirrer (such as a ENS-4A type, a SH05-3G type) and stirred for 0.5-2 hours, uniformly mixed, and then dried in a vacuum drying oven (such as a FZG-8E type) to form a liquid crystal mixture. The liquid crystal mixture described above and an ethylene-vinyl acetate copolymer are dissolved in an organic solvent (such as dichloromethane, acetone, etc.) at the predetermined ratio in Example 1, sealed in a magnetic stirrer (such as a ENS-4A type, a SH05-3G type) and stirred for 0.5-2 hours, uniformly mixed, and then dried in a vacuum drying oven (such as a FZG-8E type) to form the light-splitting material.

### Example 3

This Example provides a grating. As shown in FIG. 2, the grating 2 comprises a first substrate 24 and a second substrate 14 which are oppositely provided, wherein a light-splitting layer is provided between the first substrate 24 and the second substrate 14, the light-splitting layer comprises a plurality of light-transmitting areas and light-splitting areas which are provided at intervals, the light-splitting area is provided with a light-splitting unit, the light-splitting unit comprises a light-splitting material layer 21, and the material forming the light-splitting material layer 21 includes the light-splitting material provided in Example 1. Optionally, the light-splitting material layer 21 has a thickness in a range of 2 μm to 50 μm. Preferably, the light-splitting material layer 21 has a thickness of 10 μm or 15 μm.

When a direct-current electric field is applied, the light-splitting layer forms a three-dimensional display state, wherein the light-splitting layer in the three-dimensional display state forms a left eye parallax image corresponding to the left eye and a right eye parallax image corresponding to the right eye. In this example, the light-splitting layer of the grating 2 forms a light-shielding area and a light-transmitting area. The light-shielding area and the light-transmitting area form the left eye parallax image corresponding to the left eye and the right eye parallax image corresponding to the right eye by shielding and transmitting display light of the display panel 1. The corresponding parallax images are received by the left eye and the right eye of a viewer respectively, and are analyzed and overlapped by the brain of the viewer, such that the viewer perceives the hierarchical sense of the images and in turn a stereo perception occurs.

When the direct-current electric field is removed, the light-splitting layer maintains the three-dimensional display state. Therefore, before an electric field is applied again, the left eye and the right eye of the viewer remain in the state of receiving the left eye parallax image and the right eye parallax image, and therefore 3D display may be achieved without continuously applying an electric field to the grating. In this way, it is possible to reduce the energy consumption of liquid crystal display apparatuses, improve the display effect, and elongate the stand-by time.

When an alternating-current electric field is further applied after the direct-current electric field is removed, the light-splitting layer forms a two-dimensional display state. The light-splitting layer in the two-dimensional display state is used for transmitting light beams, and when the alternating-current electric field is removed, the light-splitting layer remains in the two-dimensional display state.

In this example, the light-splitting layer comprises a plurality of light-transmitting areas and light-splitting areas which are provided at intervals, and the light-splitting area is provided with a light-splitting unit. When a direct-current electric field is applied, the light-splitting unit forms a light-shielding state, and the light-splitting unit in the light-shielding state is used for shielding light beams. When the direct-current electric field is removed, the light-splitting unit remains in the light-shielding state. The light-splitting unit in the light-shielding state forms a light-shielding area. The light-shielding area and the light-transmitting area form the left eye parallax image corresponding to the left eye and the right eye parallax image corresponding to the right eye by shielding and transmitting display light of the display panel 1. The corresponding parallax images are received by the left eye and the right eye of a viewer respectively, and are analyzed and overlapped by the brain of the viewer, such that the viewer perceives the hierarchical sense of the images and in turn a stereo perception occurs.

When an alternating-current electric field is further applied after the direct-current electric field is removed, the light-splitting unit forms a light-transmitting state, and the light-splitting unit in the light-transmitting state is used for transmitting light beams. When the alternating-current electric field is removed, the light-splitting unit remains in the light-transmitting state. Therefore, the light-splitting area and the light-transmitting area are both in the light-transmitting state so as to achieve 2D display. In this example, since it is not required to continuously apply an electric field to the grating upon 2D display and 3D display, it is only required to apply an electric field upon the switching between 2D display and 3D display, and therefore, it is possible to reduce the energy consumption of 3D liquid crystal display apparatuses, improve the display effect, and elongate the stand-by time.

With reference to FIG. 2, the light-splitting unit comprises a first electrode 22 provided on a side of the first substrate 24 close to the second substrate 14 and a second electrode 23 provided on a side of the second substrate 14 close to the first substrate 24, wherein a light-splitting material layer 21 is provided between the first electrode 22 and the second electrode 23. The light-splitting material layer 21 is used for transmitting a light beam or shielding a light beam. A first alignment layer (not shown in the figure) is provided on a side of the first electrode 22 close to the light-splitting material layer 21, a second alignment layer (not shown in the figure) is provided on a side of the second electrode 23 close to the light-splitting material layer 21, and the light-splitting material layer 21 is provided between the first alignment layer and the second alignment layer.

In this example, the material forming the light-splitting material layer 21 includes a liquid crystal mixture and an ethylene-vinyl acetate copolymer, and the mass ratio of the liquid crystal mixture to the ethylene-vinyl acetate copolymer is in a range of 3/7 to 8/2. Preferably, the mass ratio of the liquid crystal mixture to the ethylene-vinyl acetate copolymer is 7/3, 6/4, or 5/5. Optionally, the liquid crystal mixture comprises a negative nematic liquid crystal, a chiral additive, and an ionic liquid. Optionally, the mass proportion of the negative nematic liquid crystal is in a range of 69% to 98.9%, the mass proportion of the chiral additive is in a range of 1% to 30%, and the mass proportion of the ionic liquid is in a range of 0.1% to 1%, relative to the total mass of the liquid crystal mixture. Preferably, the mass proportions of the negative nematic liquid crystal, the chiral additive, and the ionic liquid are 97.9%, 2.0%, and 0.1% respectively. Alternatively, the mass proportions of the negative nematic liquid crystal, the chiral additive, and the ionic liquid are 74.8%, 25.0%, and 0.2% respectively. Alternatively, the mass proportions of the negative nematic liquid crystal, the chiral additive, and the ionic liquid are 94.85%, 5.0%, and 0.15% respectively. The negative nematic liquid crystal, the chiral additive, and the ionic liquid are the same as those in Example 1 respectively.

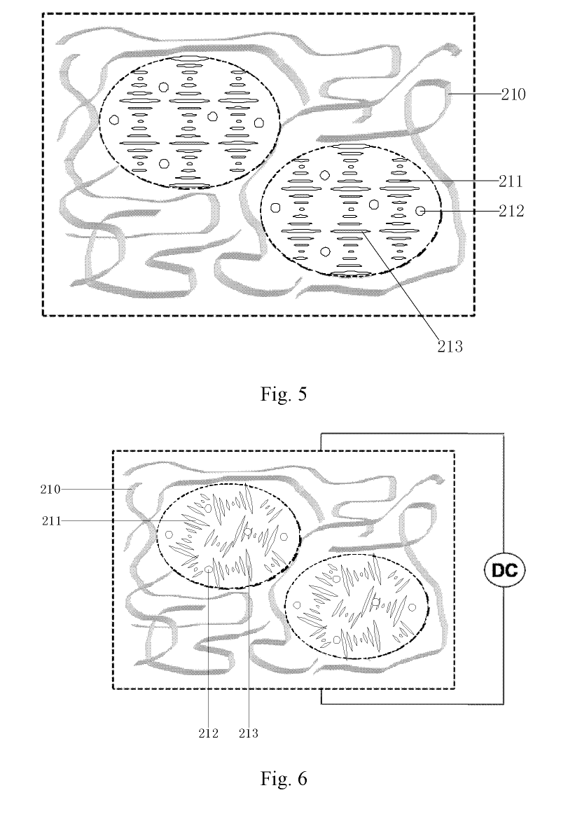

The switching between 2D display and 3D display of the grating 2 performed under the action of different electric fields is specifically illustrated below. FIG. 5 is a schematic diagram of the molecular arrangement of the light-splitting material of the light-splitting material layer 21 shown in FIG. 2 in the initial state. As shown in FIG. 5, the ethylene-vinyl acetate copolymer 210 is a high-molecular polymer which is distinguished from small molecules, and has a relatively large viscosity, a relatively high molecular weight, and a linear shape, so as to be capable of forming a network structure and being used for anchoring the molecular arrangement of small molecule substances. The ethylene-vinyl acetate copolymer 210 exhibits a network-like backbone structure and a flake-like microscopic morphology, and can stabilize small molecules in very small mesh pores, so as to be capable of fixing a liquid crystal mixture in a certain microdomain and preventing the flow of the liquid crystal mixture. Therefore, the ethylene-vinyl acetate copolymer 210 may anchor a mixture of a negative nematic liquid crystal 211, a chiral additive 212, and an ionic liquid 213 in a certain microdomain to form a thin-film like structure. In the initial state, the light-splitting layer forms a two-dimensional display state, and the light-splitting layer in the two-dimensional display state is used for transmitting light beams. At this time, a mixture containing a negative nematic liquid crystal 211, a chiral additive 212, and an ionic liquid 213 exhibits a planar texture of a cholesteric liquid crystal at room temperature. The mixture may reflect light beams having wavelengths less than 380 nm or more than 780 nm and transmit visible light having wavelengths of 380 nm to 780 nm. That is, visible light may be completely transmitted through the light-splitting material layer. At this time, the light-splitting unit exhibits a transparent state, and therefore the grating 2 is in a two-dimensional display state.

FIG. 6 is a schematic diagram of the molecular arrangement of the light-splitting material of the light-splitting material layer 21 shown in FIG. 2 when a direct-current electric field is applied. As shown in FIG. 6, when a direct-current electric field is applied, the light-splitting layer forms a three-dimensional display state, wherein the light-splitting layer in the three-dimensional display state forms a left eye parallax image corresponding to the left eye and a right eye parallax image corresponding to the right eye. In particular, when a direct-current electric field is applied, since the orientation of the negative nematic liquid crystal 211 becomes disordered under the combined action of the direct-current electric field and ion movements, the mixture containing a negative nematic liquid crystal 211, a chiral additive 212, and an ionic liquid 213 changes into a focal conic texture from a planar texture, and the molecular arrangement of the liquid crystal in the mixture becomes disordered, such that the light-splitting unit exhibits an opaque state and the grating 2 is in a three-dimensional display state.

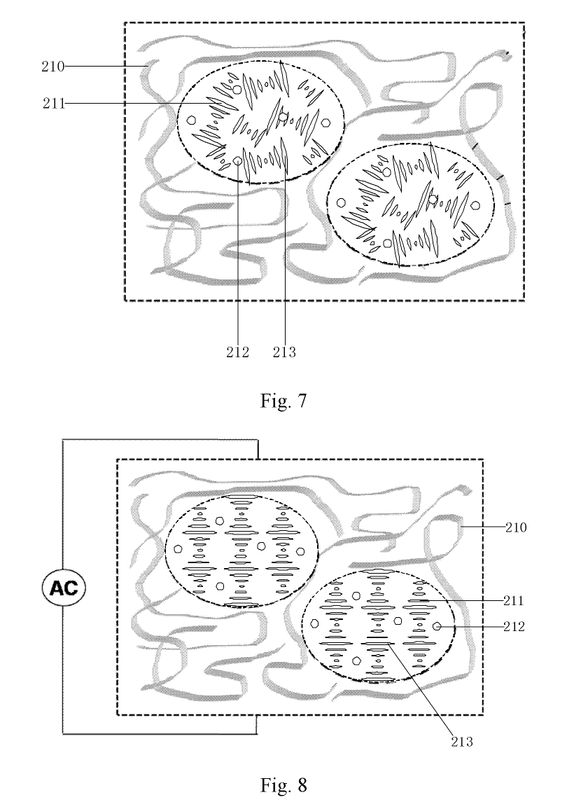

FIG. 7 is a schematic diagram of the molecular arrangement of the light-splitting material of the light-splitting material layer 21 shown in FIG. 2 when a direct-current electric field is removed. As shown in FIG. 7, after the direct-current electric field is removed, the negative nematic liquid crystal 211 remains in a disordered state, such that the light-splitting unit remains to exhibit an opaque state. Therefore, after the direct-current electric field is removed, the grating 2 remains in a three-dimensional display state.

FIG. 8 is a schematic diagram of the molecular arrangement of the light-splitting material of the light-splitting material layer 21 shown in FIG. 2 when an alternating-current electric field is applied. As shown in FIG. 8, when an alternating-current electric field is further applied after the direct-current electric field is removed, since the negative nematic liquid crystal 211 exhibits a planar orientation under the action of a high-frequency alternating-current electric field, the mixture containing a negative nematic liquid crystal 211, a chiral additive 212, and an ionic liquid 213 returns to the planar orientation state. At this time, the light-splitting unit exhibits a transparent state, and therefore the grating 2 is switched from a three-dimensional display mode to a two-dimensional display mode.

With reference to FIG. 5, after the alternating-current electric field is removed, the negative nematic liquid crystal 211 remains in a planar orientation state. Therefore, after the alternating-current electric field is removed, the grating 2 remains in a two-dimensional display state.

In the present disclosure, since it is not required to continuously apply an electric field to the grating upon 2D display and 3D display, it is only required to apply an electric field upon the switching between 2D display and 3D display, and therefore, it is possible to reduce the energy consumption of 3D liquid crystal display apparatuses, improve the display effect, and elongate the stand-by time.

### Example 4

This Example provides an application method of a grating. The grating comprises the grating provided by Example 3, and specific contents can be referred to the description of Example 3.

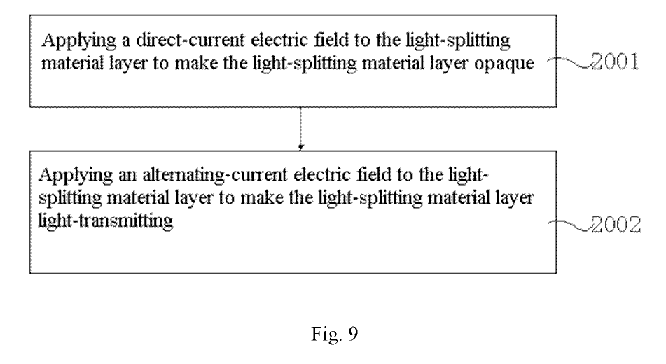

FIG. 9 is a flow chart of an application method of a grating provided in Example 4 of this disclosure. As shown in FIG. 9, the application method of the grating comprises:

(i) Step 2001: applying a direct-current electric field to the light-splitting material layer to make the light-splitting material layer opaque.

In this example, the initial state of the light-splitting material layer is a light-transmitting state. With reference to FIG. 5, the ethylene-vinyl acetate copolymer 210 is a high-molecular polymer which is distinguished from small molecules, and has a relatively large viscosity, a relatively high molecular weight, and a linear shape, so as to be capable of forming a network structure and being used for anchoring the molecular arrangement of small molecule substances. The ethylene-vinyl acetate copolymer 210 exhibits a network-like backbone structure and a flake-like microscopic morphology, and can stabilize small molecules in very small mesh pores, so as to be capable of fixing a liquid crystal mixture in a certain microdomain and preventing the flow of the liquid crystal mixture. Therefore, the ethylene-vinyl acetate copolymer 210 may anchor a mixture of a negative nematic liquid crystal 211, a chiral additive 212, and an ionic liquid 213 in a certain microdomain to form a thin-film like structure. In the initial state, the light-splitting layer forms a two-dimensional display state, and the light-splitting layer in the two-dimensional display state is used for transmitting light beams. At this time, a mixture containing a negative nematic liquid crystal 211, a chiral additive 212, and an ionic liquid 213 exhibits a planar texture of a cholesteric liquid crystal. The mixture may reflect light beams having wavelengths less than 380 nm or more than 780 nm and transmit visible light having wavelengths of 380 nm to 780 nm. That is, visible light may be completely transmitted through the light-splitting material layer. At this time, the light-splitting unit exhibits a transparent state, and therefore the grating 2 is in a two-dimensional display state.

With reference to FIG. 6, when a direct-current electric field is applied, the light-splitting layer forms a three-dimensional display state, wherein the light-splitting layer in the three-dimensional display state is used for forming a left eye parallax image corresponding to the left eye and a right eye parallax image corresponding to the right eye. In particular, when a direct-current electric field is applied, since the orientation of the negative nematic liquid crystal 211 becomes disordered under the combined action of the direct-current electric field and ion movements, the mixture containing a negative nematic liquid crystal 211, a chiral additive 212, and an ionic liquid 213 changes into a focal conic texture from a planar texture, and the molecular arrangement of the liquid crystal in the mixture becomes disordered, such that the light-splitting unit exhibits an opaque state and the grating 2 is in a three-dimensional display state.

Optionally, the direct-current electric field is removed after applying the direct-current electric field to the light-splitting material layer to maintain the light-splitting material layer in an opaque state. With reference to FIG. 7, after the direct-current electric field is removed, the negative nematic liquid crystal 211 remains in a disordered state, such that the light-splitting unit remains to exhibit an opaque state. Therefore, after the direct-current electric field is removed, the grating 2 remains in a three-dimensional display state.

(ii) Step 2002: applying an alternating-current electric field to the light-splitting material layer to make the light-splitting material layer light-transmitting.

With reference to FIG. 8, when an alternating-current electric field is further applied after the direct-current electric field is removed, since the negative nematic liquid crystal 211 exhibits a planar orientation under the action of a high-frequency alternating-current electric field, the mixture containing a negative nematic liquid crystal 211, a chiral additive 212, and an ionic liquid 213 returns to the planar orientation state. At this time, the light-splitting unit exhibits a transparent state, and therefore the grating 2 is switched from a three-dimensional display mode to a two-dimensional display mode.

Optionally, the alternating-current electric field is removed after applying the alternating-current electric field to the light-splitting material layer to maintain the light-splitting material layer in a light-transmitting state. With reference to FIG. 5, after the alternating-current electric field is removed, the negative nematic liquid crystal 211 remains in a planar orientation state. Therefore, after the alternating-current electric field is removed, the grating 2 remains in the two-dimensional display state.

In the present disclosure, since it is not required to continuously apply an electric field to the grating upon 2D display and 3D display, it is only required to apply an electric field upon the switching between 2D display and 3D display, and therefore, it is possible to reduce the energy consumption of 3D liquid crystal display apparatuses, improve the display effect, and elongate the stand-by time.

### Example 5

This example provides a 3D display apparatus, which comprises a display panel and the grating provided in Example 3. The specific contents of the grating can be referred to the description in Example 3. With reference to FIG. 2, the grating 2 is provided on a light emergent side of the display panel 1, the display panel 1 comprises a third substrate 14 and a fourth substrate 12 which are oppositely provided, a liquid crystal layer 13 is provided between the third substrate 14 and the fourth substrate 12, and the second substrate 14 on a light incident side of the grating and the third substrate 14 on the light emergent side of the display panel 1 are the same substrate. In this example, the light-splitting layer of the grating 2 is directly provided on the third substrate 14 of the display panel 1. That is, the grating 2 and the display panel 1 share the same substrate so as to reduce the total thickness of the 3D display apparatus. Optionally, a first polarizer 11 is provided on the light incident side of the fourth substrate 12, and a second polarizer 15 is provided on the light emergent side of the first substrate 24.

In the 3D display apparatus provided in this example, the grating 2 comprises a first substrate 24 and a second substrate 14 which are oppositely provided, wherein a light-splitting layer is provided between the first substrate 24 and the second substrate 14, the light-splitting layer comprises a light-splitting material layer 21, and the material forming the light-splitting material layer 21 includes the light-splitting material provided in Example 1. When a first electric field is applied, the light-splitting layer forms a three-dimensional display state, and the light-splitting layer in the three-dimensional display state forms a left eye parallax image corresponding to the left eye and a right eye parallax image corresponding to the right eye. When the first electric field is removed, the light-splitting layer maintains the three-dimensional display state. In this example, since it is not required to continuously apply an electric field to the grating upon 2D display and 3D display, it is only required to apply an electric field upon the switching between 2D display and 3D display, and therefore, it is possible to reduce the energy consumption of 3D liquid crystal display apparatuses, improve the display effect, and elongate the stand-by time.

It can be understood that the above embodiments are merely exemplary embodiments used for illustrating the principle of this disclosure. However, the present disclosure is not limited thereto. With respect to those of ordinary skill in the art, various variations and modifications can be made without departing from the spirit and the substance of this disclosure. These variations and modifications are also considered as the scope protected by this disclosure.

1. A light-splitting material, comprising a liquid crystal mixture and an ethylene-vinyl acetate copolymer, wherein the liquid crystal mixture comprises a negative nematic liquid crystal, a chiral additive and an ionic liquid, and the mass ratio of the liquid crystal mixture to the ethylene-vinyl acetate copolymer is in a range of 3/7 to 8/2.

2. The light-splitting material according to claim 1, wherein the mass ratio of the liquid crystal mixture to the ethylene-vinyl acetate copolymer is 7/3, 6/4, or 5/5.

3. The light-splitting material according to claim 1, wherein the mass proportion of the negative nematic liquid crystal is in a range of 69% to 98.9%, the mass proportion of the chiral additive is in a range of 1% to 30%, and the mass proportion of the ionic liquid is in a range of 0.1% to 1%, relative to the total mass of the liquid crystal mixture.

4. The light-splitting material according to claim 3, wherein:
the mass proportions of the negative nematic liquid crystal, the chiral additive, and the ionic liquid are 97.9%, 2.0%, and 0.1% respectively; or
the mass proportions of the negative nematic liquid crystal, the chiral additive, and the ionic liquid are 74.8%, 25.0%, and 0.2% respectively; or
the mass proportions of the negative nematic liquid crystal, the chiral additive, and the ionic liquid are 94.85%, 5.0%, and 0.15% respectively.

5. A preparation method of the light-splitting material according to claim 1, wherein the preparation method of the light-splitting material comprises the steps of:
uniformly mixing a negative nematic liquid crystal, a chiral additive, and an ionic liquid to form a liquid crystal mixture; and
uniformly mixing the liquid crystal mixture with an ethylene-vinyl acetate copolymer to form the light-splitting material.

6. A grating, comprising a first substrate and a second substrate which are oppositely provided, wherein a light-splitting layer is provided between the first substrate and the second substrate, the light-splitting layer comprises a plurality of light-transmitting areas and light-splitting areas which are provided at intervals, the light-splitting area is provided with a light-splitting unit, the light-splitting unit comprises a light-splitting material layer, and the material forming the light-splitting material layer comprises the light-splitting material of claim 1.

7. The grating according to claim 6, wherein the light-splitting unit comprises a first electrode which is provided on a side of the first substrate close to the second substrate and a second electrode which is provided on a side of the second substrate close to the first substrate, wherein the light-splitting material layer is provided between the first electrode and the second electrode.

8. The grating according to claim 7, wherein a first alignment layer is provided on a side of the first electrode close to the light-splitting material layer, a second alignment layer is provided on a side of the second electrode close to the light-splitting material layer, and the light-splitting material layer is provided between the first alignment layer and the second alignment layer.

9. The grating according to claim 6, wherein the light-splitting material layer has a thickness in a range of 2 μm to 50 μm.

10. The grating according to claim 9, wherein the light-splitting material layer has a thickness of 10 μm or 15 μm.

11. An application method of the grating according to claim 6, wherein the application method of the grating comprises the steps of:
applying a direct-current electric field to the light-splitting material layer to make the light-splitting material layer opaque; and
applying an alternating-current electric field to the light-splitting material layer to make the light-splitting material layer light-transmitting.

12. The application method of the grating according to claim 11, further comprising the step of:
removing the direct-current electric field after applying the direct-current electric field to the light-splitting material layer, to maintain the light-splitting material layer in an opaque state.

13. The application method of the grating according to claim 11, further comprising the step of:
removing the alternating-current electric field after applying the alternating-current electric field to the light-splitting material layer to maintain the light-splitting material layer in a light-transmitting state.

14. The application method of the grating according to claim 11, wherein the initial state of the light-splitting material layer to which an electric field is not applied is a light-transmitting state.

15. A 3D display apparatus, comprising a display panel and the grating of claim 6, wherein the grating is provided on a light emergent side of the display panel, the display panel comprises a third substrate and a fourth substrate which are oppositely provided, and the second substrate on a light incident side of the grating and the third substrate on the light emergent side of the display panel are the same substrate.

16. The preparation method according to claim 5, wherein the mass ratio of the liquid crystal mixture to the ethylene-vinyl acetate copolymer is 7/3, 6/4, or 5/5.

17. The preparation method according to claim 5, wherein the mass proportion of the negative nematic liquid crystal is in a range of 69% to 98.9%, the mass proportion of the chiral additive is in a range of 1% to 30%, and the mass proportion of the ionic liquid is in a range of 0.1% to 1%, relative to the total mass of the liquid crystal mixture.

18. The preparation method according to claim 17, wherein:
the mass proportions of the negative nematic liquid crystal, the chiral additive, and the ionic liquid are 97.9%, 2.0%, and 0.1% respectively; or
the mass proportions of the negative nematic liquid crystal, the chiral additive, and the ionic liquid are 74.8%, 25.0%, and 0.2% respectively; or
the mass proportions of the negative nematic liquid crystal, the chiral additive, and the ionic liquid are 94.85%, 5.0%, and 0.15% respectively.

19. The grating according to claim 6, wherein the mass ratio of the liquid crystal mixture to the ethylene-vinyl acetate copolymer is 7/3, 6/4, or 5/5.

20. The grating according to claim 6, wherein the mass proportion of the negative nematic liquid crystal is in a range of 69% to 98.9%, the mass proportion of the chiral additive is in a range of 1% to 30%, and the mass proportion of the ionic liquid is in a range of 0.1% to 1%, relative to the total mass of the liquid crystal mixture.
